(19) United States
(12) Patent Application Publication
(10) Pub. No.: US 2004/0264452 A1
(43) Pub. Date: Dec. 30, 2004

(54) Apparatus, and associated method, for embedding control information into packet formatted data

(76) Inventor: Gaurav Mittal, Tampere (FI)

Correspondence Address: Robert H. Kelly, Scheef & Stone, L.L.P., Suite 1400, 5956 Sherry Lane, Dallas, TX, 75225, US

(21) Appl. No.: 10/603,575

(22) Filed: Jun. 25, 2003

(51) Int. Cl. H04L 12/28

(52) U.S. Cl. 370/389; 370/395.5; 370/401

(57) ABSTRACT

Apparatus, and an associated method, for embedding-control information into a data packet that is communicated during effectuation of a packet communication service. A formatter formats information that is to be communicated into an RTP-formatted data packet. A header extension forms part of the data packet and includes fields that are populated with values of control information. The data packet, once formed, is communicated to a receiving station whereat the header extension is identified and the values contained therein are extracted by an extractor.

The present invention relates generally to a manner by which to convey control information between communication stations that are parties to a real time communication session, such as a communication session in which RTP-formatted data is communicated. More particularly, the present invention relates to apparatus, and an associated method, by which to embed the control information in header extensions of RTP-formatted data packets.

The control information is communicated as part of otherwise-conventional communication of the data packets and does not require significant amounts of communication resources for its communication. When implemented in a radio communication system, for instance, improved control over the effectuation of a real time communication service, such as a VoIP or PTT communication service, is provided. The control information provides, amongst other things, the capability to pause, i.e., stop and start, the communication of the data packets pursuant to the communication service.

### BACKGROUND OF THE INVENTION

Many aspects of modem society require the communication of data pursuant to the effectuation of communication services. And, the need to communicate data shall likely continue and perhaps increase.

Data is communicated by way of a communication system. A communication system includes, at a minimum, a first communication station and a second communication station. The communication stations are interconnected by way of a communication channel. Data is originated at a first of the communication stations, referred to as a sending station. The data is sent by the sending station upon the communication channel to be delivered to at least a second of the communication stations, referred to as a receiving station. The receiving station detects the data communicated thereto and operates to recover the informational content thereof.

A radio communication system is a communication system that utilizes radio channels upon which to communicate data between the communication stations. The radio channels are formed upon radio links defined upon a radio air interface. Wireline communication systems, in contrast, require a fixed, i.e., a wireline, connection between the communication stations upon which to form communication channels that are permitting of the communication of data therebetween.

Radio communication systems provide various advantages that sometimes favor their use over corresponding wireline communication systems. The physical infrastructure of a radio communication system, for instance, is generally relatively less costly to install than that of a corresponding wireline communication system. Initial deployment costs of a radio communication system, therefore, are generally less than those of corresponding wireline communication systems. Additionally, and significantly, a radio communication system can be implemented as a mobile communication system. In a mobile communication system, communication mobility is provided. That is, one or more of the communication stations of a mobile communication system is mobile and not limited to operation at a fixed position.

A cellular communication system is a type of mobile radio communication system that has achieved significant levels of usage. The networks of various cellular communication systems have been deployed to encompass many populated portions of the world. Telephonic communications are provided by way of the networks of cellular communication systems through the use of mobile stations. That is, radio communications are effectuated during operation of the cellular communication system between a network part of the communication system and a mobile station to effectuate a communication service.

The area encompassed by the cellular communication system is defined by the placement of fixed-site base transceiver stations. The base transceiver stations each define a coverage area, referred to as a cell, and the aggregated areas of the cells defined by the coverage areas of all of the base transceiver stations together define the area encompassed by the system. The network part of the cellular communication system also includes control entities and entities permitting connection with other communication networks, such as PSTNs (public-switched, telephonic networks) or PDNs (packet data networks), such as the Internet.

A mobile station, when used to communicate data, usually communicates with the base transceiver positioned in closest proximity to the mobile station. Viz., the mobile station communicates with the base transceiver station that defines the cell in which the mobile station is positioned.

Successive generations of cellular communication systems have been developed and deployed. And, new-generation systems are being deployed and others are under development. For instance, standardization of so-called fourth generation (4G) communication systems are ongoing. In general, such systems are predicated at least in part upon packet-based communication schemes. In a packet communication scheme, data that is to be communicated is formatted into packets and the packet-formatted data is communicated in the form of a series of data packets to effectuate the communication of the data pursuant to a communication service.

Various, standard packet formatting protocols have been promulgated and packet formatting in conformity the promulgated standards is used. Formatting is sometimes performed at more than one logical layer of a communication station.

An exemplary packet-formatting protocol is a real time transport protocol (RTP). The real time transport protocol provides network transport functions particularly suitable for the communication of real time data in which the sequence of delivery of data packets must be maintained. The real time transport protocol, however, fails to provide several control-related mechanisms needed for its use in the aforementioned fourth-generation cellular communication system. Namely, the real time transport protocol fails to address resource reservation procedures and also fails to guarantee quality of service (QoS) services.

While the real time transport protocol is associated with a real time transport control protocol (RTCP), the real time transport control protocol is bandwidth intensive, i.e., requires significant levels of bandwidth allocation for its communication. As bandwidth resources, particularly in radio communications, must generally be minimized, the real time transport protocol is not generally a practical manner by which to provide control mechanisms that are otherwise lacking in communications effectuated using real time transport protocol formatting.

An improved manner by which to communicate control information pursuant to a communication session in which real time transport protocol-formatted data is communicated is therefore needed.

It is in light of this background information related to communication of packet-formatted data that the significant improvements of the present invention have evolved.

### SUMMARY OF THE INVENTION

The present invention, accordingly, advantageously provides apparatus, and an associated method, by which to convey control information that are parties to a real time communication session, such as a communication session in which RTP-formatted data is communicated.

Through operation of an embodiment of the present invention, a manner is provided by which to embed control information in header extensions of RTP-formatted data packets.

By embedding the control information in the header extensions of the data packets, the control information is communicated as parts of otherwise-conventional communications during a communication session to effectuate a communication service. Reduced amounts of additional communication resources are required, in contrast, e.g., to the use of RTCP (Real time Transport Control Protocol) signaling. The control information provides to a receiving station that receives the RTP-formatted data packets, the capability to, e.g., start, stop, and pause the communication of the data packets pursuant to effectuation of a real time communication service.

In one aspect of the present invention, a formatter is provided for formatting data into RTP-formatted data packets. The data packets include a header portion, a header extension portion, and a payload portion. The header extension portion is populated with values of the control information, thereby to embed the control information into the data packet. When the data packet is communicated to a receiving station, the control information is extracted from the header extension and thereafter utilized to facilitate control of communications during the communication session in which the communication service is effectuated.

In another aspect of the present invention, the header extension is formatted to include an INFO field that is populated with values indicating various control information that is used by a receiving station that receives the data packet of which the header extension forms a portion. The INFO field is, e.g., of a three-bit length, and eight separate control commands are associated with the eight separate values of which the three-bit length INFO field can take. Additional fields are defined at the header extension and selectably provide further control information that further define values that populate the INFO field. The additional fields include a defined by profile field and a length field.

When a data packet including the control information is communicated to a receiving station, an extractor, embodied at the receiving station, operates to extract the control information contained in the header extension and to use the extracted information, selectably, depending upon the values of the control information, to control operation of the receiving station upon the received data packet as well as, selectably, also data packets that are subsequently to be delivered to the receiving station.

When, the INFO field is populated with values of 1, 2, or 3, the receiving station uses the values of the extracted information to know various aspects of the sending station. Depending upon the value populating the INFO field, the sending station identifies by the value populating the field that the sending station shall pause the data transfer or to indicate that the packet containing the value is the final data packet to be communicated during a particular communication session. That is to say, the value of the INFO field, in this situation, indicates a stop of the data transfer. By extracting and interpreting the values contained in the INFO field, the receiving station is made aware of a delay, or termination, in the sending of subsequent data packets.

In another aspect of the present invention, the header portion of the data packet includes an indicator field, e.g., a single-bit field, to indicate whether the header extension forms a portion of the data packet. When the field is populated with a selected value, the value indicates the header extension to form a part of the data packet. And, when the data packet is delivered to a receiving station, the value populating the indicator field is extracted to determine whether the data packet includes a header extension.

Thereby, through use of the header extension and definition of fields thereof, control information is communicated between communication stations that are parties to a communication session. RTP-formatted, or other, data packets communicated pursuant to effectuation of a real-time communication service include control information embedded therein. Control information is extracted at a receiving station, thereby to provide the receiving station with control information related to the communication session and the communication of data pursuant thereto.

In these and other aspects, therefore, apparatus, and an associated method, is provided for a data communication device operable in a communication system. During operation, data is communicated pursuant to a data communication service. Control information is embedded into individual packets of the data communicated pursuant to the communication service. A formatter is adapted to receive indications representative of the data to be communicated pursuant to the packet communication service. The formatter formats the indications into the individual packets. Each of at least selected ones of the individual packets are formatted to include a control field that is populated with the values that identify session control information used in control of effectuation of the packet communication service.

A more complete appreciation of the present invention and the scope thereof can be obtained from the accompanying drawings which are briefly summarized below, the detailed description of the presently preferred embodiments of the invention, and the appended claims.

### BRIEF DESCRIPTION OF THE DRAWINGS

FIG. 1 illustrates a functional block diagram of a radio communication system in which an embodiment of the present invention is operable.

FIG. 2 illustrates a representation of an exemplary data packet formed pursuant to operation of an embodiment of the present invention.

FIG. 3 illustrates a representation of an exemplary header extension that forms a portion of the data packet shown in FIG. 2.

FIG. 4 illustrates a method flow diagram that lists the method steps of the method of operation of an embodiment of the present invention.

### DETAILED DESCRIPTION

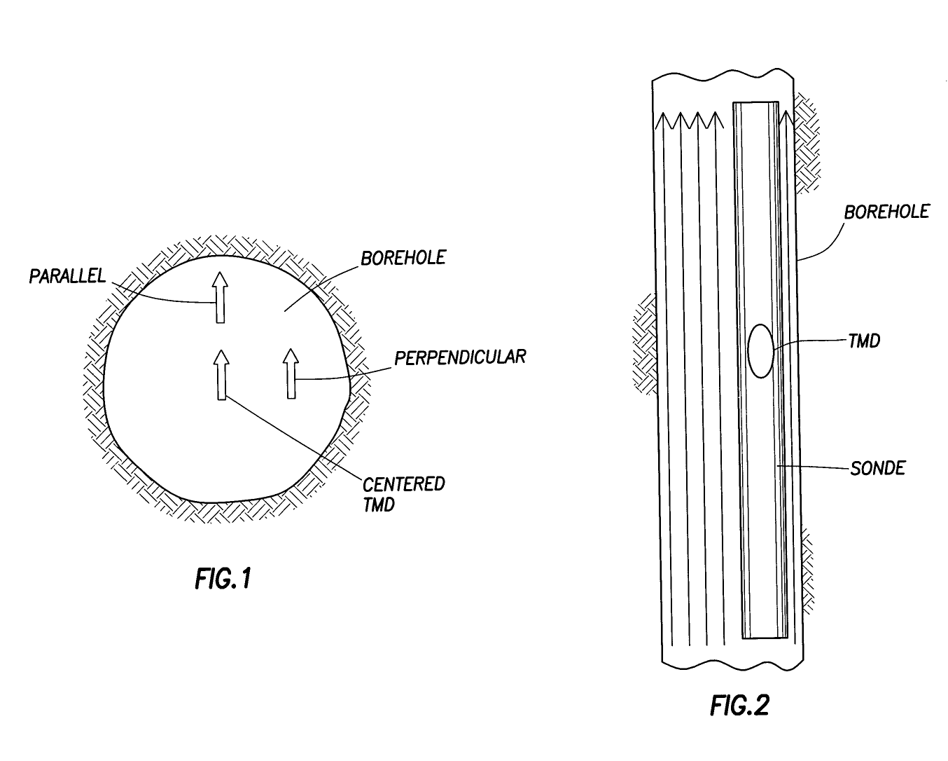

Referring first to FIG. 1, a communication system, shown generally at 10, provides for the communication of packet-formatted data with mobile stations, of which the mobile station 12 is exemplary. Packet-formatted data is communicated during operation of the communication system to effectuate communication services, including real time communication services. Exemplary real time communication services include VoIP (Voice over Internet Protocol) and PTT communication services.

In the exemplary implementation, the communication system comprises a communication system that is operable in general conformity with an IETF-promulgated mobile radio communication system, i.e., a so-called fourth generation (4G) communication system. The communication system however, is also representative of other types of packet-based, communication systems. Therefore, while the following description shall describe exemplary operation of the communication system with respect to its implementation as a mobile radio communication system operable generally pursuant to an IETF-promulgated operating specification, the teachings of the present invention are analogously also applicable to other types of communication systems is which packet-formatted data is communicated.

Data is communicated between the mobile stations and a network part of the communication system, by way of radio channels defined upon a radio air interface. Data is communicated by the network part upon forward-link, or down-link, channels, here indicated by the arrow 16. And, data is communicated by the mobile station to the network part by way of up-link, or reverse-link, channels, here indicated by the arrow 18.

The network part includes a radio access network that includes base transceiver stations (BTSs) 22, positioned at selected locations throughout an area that is encompassed by the communication system. A single base transceiver station is shown in the Figure. Each base transceiver station defines a cell, and the mobile station generally communicates with the base transceiver station that defines the cell in which the mobile station is positioned. More generally, the mobile station 12 and the base transceiver station 22 are representative of any set of communication stations between which packet-formatted data is communicated during a communication session to effectuate a communication service. In the exemplary implementation, packet-formatted data is communicated by either one of, or by both, the mobile station and the base transceiver station.

The radio access network of the network part of the communication system also includes a controller 28, such as a radio network controller, or base station controller, or a functional equivalent thereof. The controller -operates to control various aspects of the radio access network, including operation of the base transceiver stations that are, as illustrated, coupled thereto. The control entity is coupled to a gateway 32 that forms a gateway between the radio access network and other portions of the network part of the communication system. Here, the gateway connects the radio access network to a packet data network (PDN) 34, such as the Internet. A correspondent node (CN) 38 is coupled to the packet data network. The correspondent node is representative of any data source or target at which data is originated or data is terminated during a communication session with the mobile station.

For instance, data originated at the correspondent node for communication to the mobile station 12 is routed through the network part of the communication system to the base transceiver station, and the base transceiver station transmits the data to the mobile station. The base transceiver station includes apparatus 44 of an embodiment of the present invention. In other implementations, the apparatus is embodied at other entities of the network part of the communication system. And, the mobile station also includes apparatus 44 of an embodiment of the present invention.

The apparatus 44 embodied at the base transceiver station includes a formatter 46 to which data that is to be communicated pursuant to a communication session is provided, here indicated by way of the line 48. Control information is also provided to the formatter, here indicated by way of the line 52. The formatter 46 operates to format the data into RTP-formatted data packets in which the payload portions of the data packets are formed of the data provided to the formatter on the line 48. Control information provided to the formatter on the line 52 also form portions of the RTP-formatted data. RTP-formatted data packets formed thereby are transmitted upon forward link channels for delivery to the mobile station. The apparatus 44 embodied at the mobile station includes an extractor 56 that is coupled to receive circuitry, (not separately shown) of the mobile station. The extractor operates to extract the control information from the data packets that are delivered to the mobile station. The receive circuitry operates upon the payload portions of the data packets. Here, the line 58 is representative of the data applied to the extractor at which the control information is extracted from the data packets. The control information, once extracted by the extractor, is used, depending upon the values of the information, to inform the mobile station of communication session information, and, selectably, also to control subsequent operation of the mobile station.

The apparatus 44 of the mobile station also includes a formatter 46 to format data originated at the mobile station for communication to the network part of the communication system. And, the apparatus 44 embodied at the base transceiver station includes an extractor 56 to extract control information from data packets communicated by the mobile station to the network part.

Because control information is embedded in the data packets that are communicated pursuant to effectuation of a communication service, better control is facilitated over communications. Control is provided, for instance, to indicate start and stop, i.e, pause operations during communication of real time data. By embedding the control information in the data packets, the amount of additional communication resources that must be allocated for the communication of the control information is modest. And, control information, not readily communicated in RTP-formatted data communications is readily available to form part of an RTP-formatted data formed pursuant to operation of the apparatus 44.

FIG. 2 illustrates an exemplary data packet, shown generally at 62, that is formed during operation of a formatter 46, shown in FIG. 1. The data packet is an RTP-formatted data packet and includes a header portion 64, a header extension portion 66, and a payload portion 68. The information data that is to be communicated during the communication session is formatted into the payload portion 68 of the data packet. The header portion 64 includes conventional header information and here also includes an identifier field 72 that, when populated with a selected logical value, e.g., a logical “1” value, indicates the presence of a header extension 66 concatenated to the header. The header extension is populated during operation of an embodiment of the present invention with values of control information, thereby to embed the control information into the data packet. When the data packet is transmitted and delivered to a receiving station, the control information is extracted from the header extension and used at the receiving station for control purposes to facilitate effectuation of a communication service pursuant to which the data packets are communicated.

FIG. 3 illustrates the header extension 66 shown to form a portion of the data packet 62 by the formatter 46 (shown in FIG. 1) during operation of an embodiment of the present invention. The fields include an INFO field 74, a “defined by profile” field 76, and a length field 78. And, a padding bit 84 separates the INFO and defined by profile fields.

The header field includes, amongst other things, a sequence number, a time stamp, a synchronization source (SSRC) identifier, and contributing source (CSRC) identifiers.

The INFO field is of a length of three bits, and the field is populated with any of eight separate values. The padding bit is a single bit length, and the defined by profile field is of a length of twelve bits. The length field is of a length of sixteen bits.

When the INFO field is populated with a value of one, the value indicates the header extension to be a normal header extension. When the value of the INFO field is of a value of two, the value represents the start and stop (pause) information. Values contained in the defined by profile field are used in accordance with an RTP profile. When the INFO field is populated with a value of three, stop information is represented. Values contained in the defined by profile field indicate the reason for terminating the communication session. And, when the INFO field is populated with a value of four, application dependent data is represented. Length bits indicate the amount of data. Defined by profile bits contained in the defined by profile field are used in accordance with the RTP-profile.

Thereby, when the values populating the INFO field are set to 1, 2, or 3, the receiving station uses the extracted information to become aware of aspects of the sending station. For instance, the sending station might want to pause the data transfer. Or, the sending station whereat the data is formatted may want to indicate that the data packet being transmitted is the final packet that the receiving station shall receive from the sending station for a particular communication session. This, in essence, is a command to stop data transfer. And, if the INFO field is set to a value of four, then the receiving station acts with respect to the data of that packet.

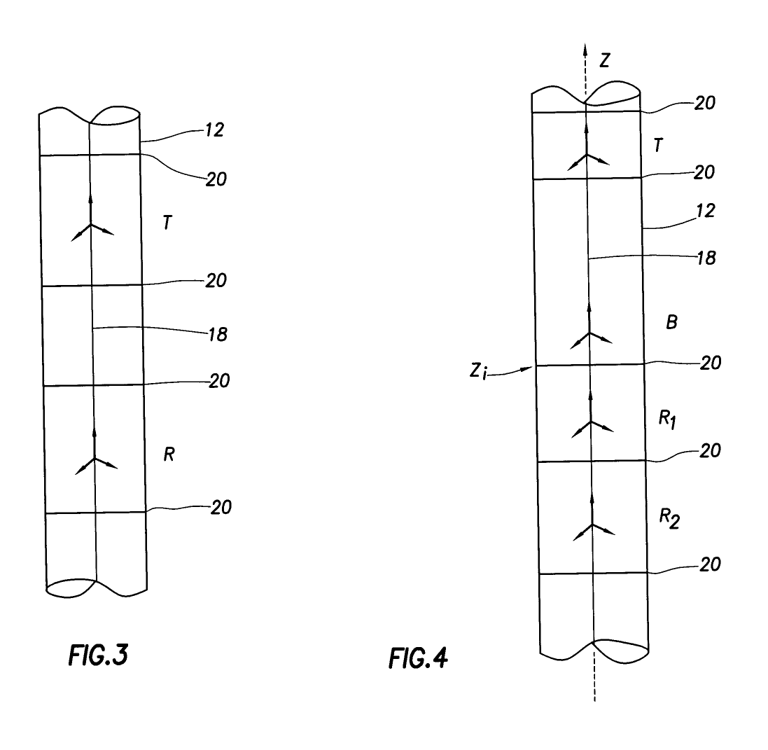

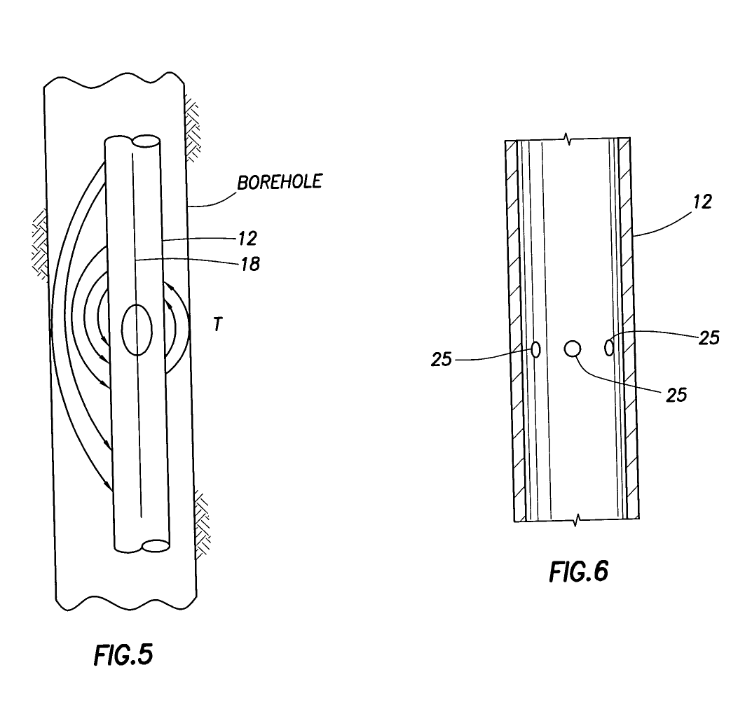

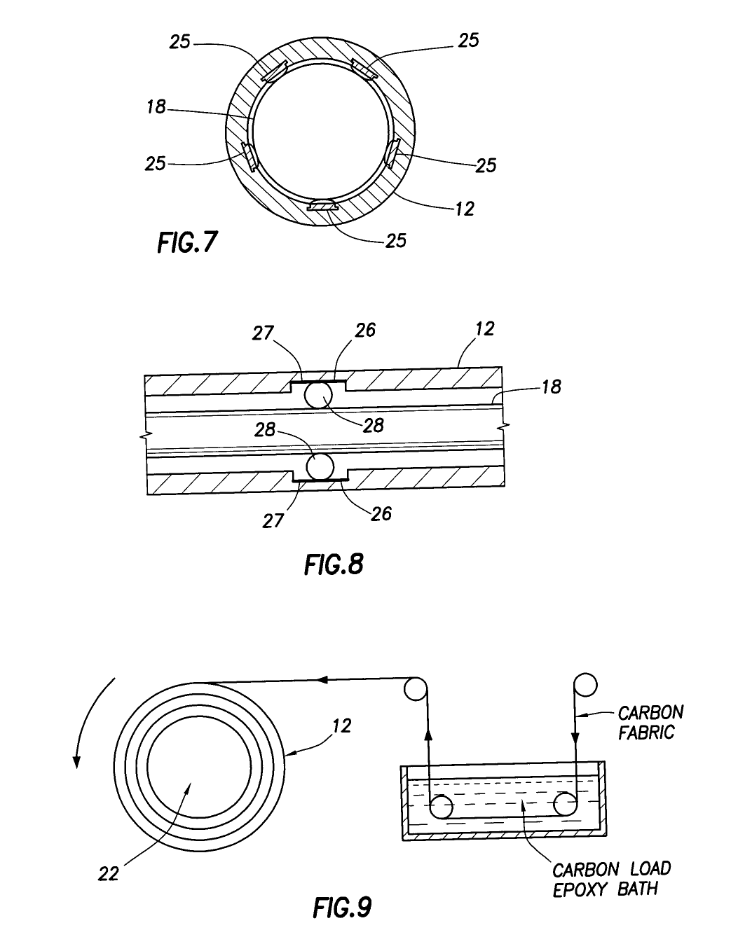

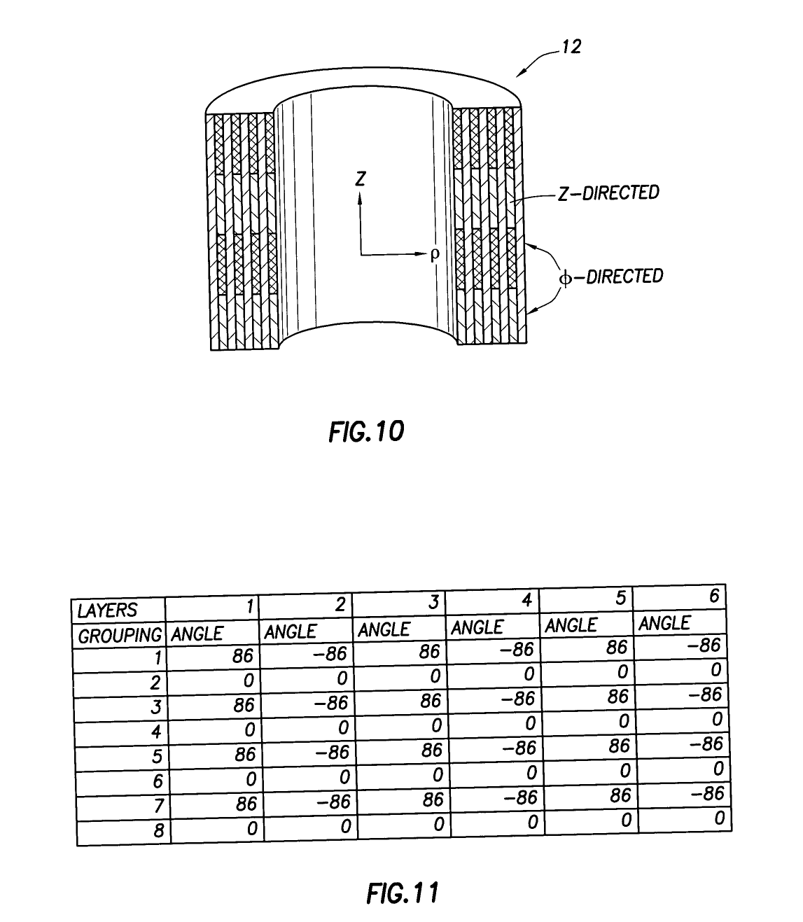

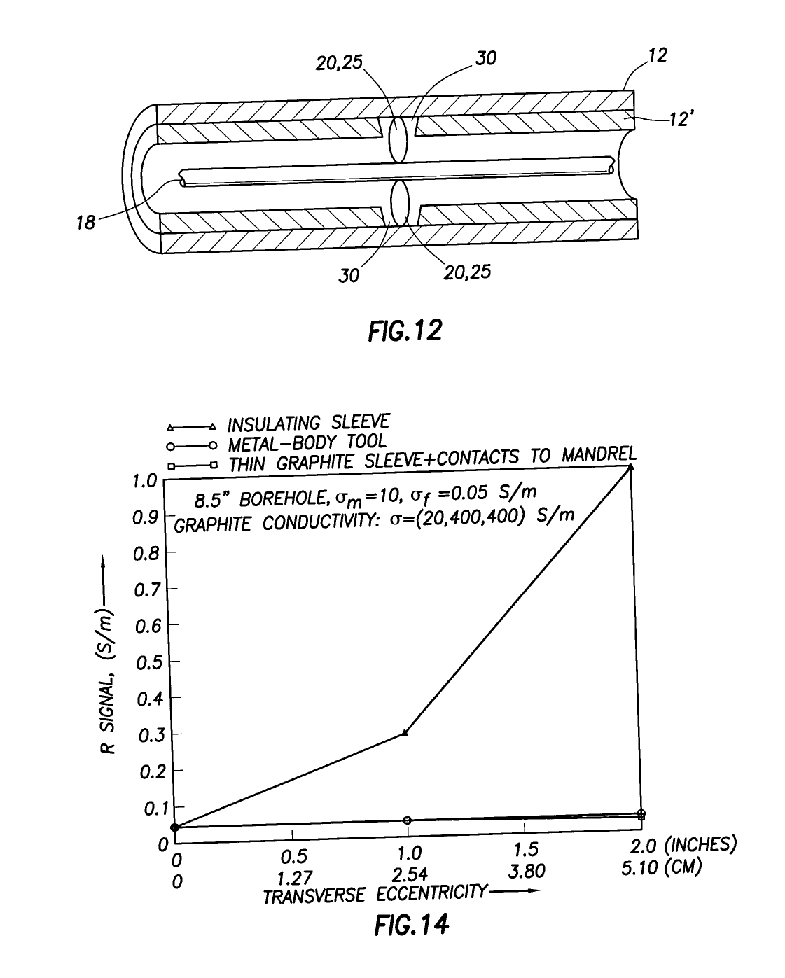

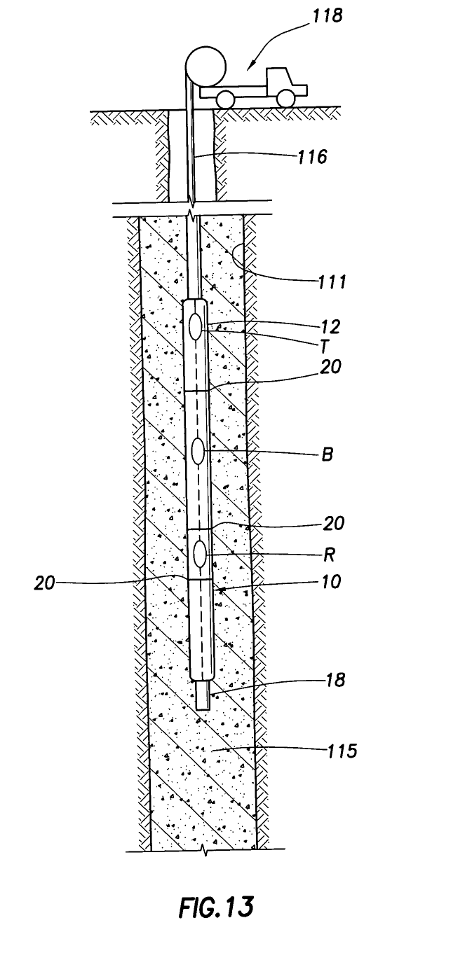

FIG. 4 illustrates a method, shown generally at 84. The method embeds control information into individual packets of data that is communicated pursuant to effectuation of a packet communication service.

First, and as indicated by the block 86, indications representative of the data to be communicated pursuant to the packet communication service are obtained. Then, and as indicated by the block 88, the indications are formatted into individual packets. Each of at least selected ones of the individual packets are formatted to include a control field that is populated with values that identify session control information used in control of the communication service.

Thereby, the control information is embedded in the data packet, to be communicated between the communication stations during a communication session. The control information is used at a receiving station that receives the data packet and appropriate control is effectuated as a result thereof.

The preferred descriptions are of the preferred examples for implementing the invention, and the scope of the invention should not necessarily be limited by this description. The scope of the present invention is defined by the following claims.

1. In a data communication device operable in a communication system to communicate data pursuant to a packet communication service, an improvement of apparatus for embedding control information into individual packets of the data communicated pursuant to the communication service, said apparatus comprising:
a formatter adapted to receive indications representative of the data to be communicated pursuant to the packet communication service, said formatter for formatting the indications into the individual packets, each of at least selected ones of the individual packets formatted to include a control field that is populated with values that identify session control information, used in control of effectuation of the packet communication service.

2. The apparatus of claim 1 wherein the individual packets into which the control information is embedded comprise RTP-formatted packets, and wherein said formatter formats RTP-formatted packets to include the control field.

3. The apparatus of claim 2 wherein each of the selected ones of the RTP-formatted packets comprise a header part and a header extension part and wherein the control field is embodied at the header extension part.

4. The apparatus of claim 3 wherein each of the header parts of the RTP-formatted packets includes an indication field to indicate presence of the header extension part and wherein said formatter further populates the indication field to indicate the presence of the header extension part.

5. The apparatus of claim 3 wherein the header extension part comprises a first portion and at least a second portion, the first portion comprising the control field and wherein said formatter populates the first portion of the header extension part with values of the control information.

6. The apparatus of claim 3 wherein the control field is selectably populated with first values, the first values indicating remaining portions of the header extension part to be non-packet-communication-service, control-information related.

7. The apparatus of claim 3 wherein the control field is selectably populated with second values, the second values indicative of delay of communication of subsequent data packets communicated pursuant to the packet communication service.

8. The apparatus of claim 3 wherein the control field is selectably populated with third values, the third values indicative of termination of communication of subsequent data packets pursuant to the packet communication service.

9. The apparatus of claim 3 wherein the control field is selectably populated with fourth values, the fourth values indicating the data of the data packet associated therewith to be application-dependent.

10. The apparatus of claim 3 wherein the control field embodied at the header extension part includes a first section of a three-bit length.

11. The apparatus of claim 10 wherein the control field embodied at the header extension part further includes a second section of a seventeen-bit length.

12. The apparatus of claim 11 wherein the first section comprises an INFO field and wherein the section comprises a defined-by-profile field.

13. The apparatus of claim 11 wherein the first section and the second section are separated by at least a first bit forming a padding field.

14. The apparatus of claim 11 wherein the control field embodied at the header extension part further includes a third section, the third section populated with values when the first section is of selected values.

15. The apparatus of claim 1 wherein the packet communication service comprises a real time communication service and wherein the control field that said formatter formats each of the at least selected ones of the individual packets to include comprises pause information associated with subsequently-transmitted ones of the individual packets.

16. In a method of communicating in a data communication system having a data communication device for communicating data pursuant to a packet communication service, an improvement of a method for embedding control information into individual packets of the data pursuant to the packet communication service, said method comprising:
obtaining indications representative of the data to be communicated pursuant to the packet communication service; and
formatting the indications into the individual packets, each of at least selected ones of the individual packets formatted to include a control field that is populated with values that identify session control information used in control of the packet communication service.

17. The method of claim 16 wherein the individual packets into which the control information is formatted during said operation of formatting to include comprise RTP (Real Time Protocol) packets.

18. The method of claim 17 wherein each of the selected ones of the RTP-formatted packets comprise a header part and a header extension part and wherein the control information formatted during said operation of formatting is formatted into the header extension part.

19. The method of claim 16 wherein the packet communication service comprises a real time communication service and wherein the control field into which each of the at least the selected ones of the individual packets is formatted to include comprises pause information associated with subsequently transmitted ones of the individual packets.

20. The method of claim 16 further comprising the operations of:
sending the individual packets to a data receiving device;
detecting, at the data receiving device, the individual packets; and
extracting the control information therefrom.
